(19) United States
(12) Patent Application Publication
(10) Pub. No.: US 2005/0101414 A1
(43) Pub. Date: May 12, 2005

(54) Wind strength and direction indicator device

(76) Inventor: John J. DiGregorio, Miramar, FL (US)

Correspondence Address: David P. Lhota;Steams Weaver Miller,, Suite 1900, 200 East Broward Boulevard, Fort Lauderdale, FL, 33301, US

(21) Appl. No.: 10/979,545

(22) Filed: Nov. 1, 2004

Related U.S. Application Data
(60) Provisional application No. 60/517,859, filed on Nov. 6, 2003.

(51) Int. Cl. A63B 57/00; G01W 1/02

(52) U.S. Cl. 473/407; 73/170.01

(57) ABSTRACT

A wind strength and direction indicator comprising a portable, narrow, flexible ribbon having a hook-and-loop fastening system for releasably attaching the ribbon to a golf bag, club, and, or cart to provide an indication of the direction the wind is blowing and its relative strength.

### CROSS REFERENCE TO RELATED APPLICATIONS

This application claims the benefit of provisional patent application Ser. No. 60/517,859 filed Nov. 6, 2003.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a golfing accessory, and, more particularly to a golfing accessory that allows a golfer to tell which way and how hard the wind is blowing to facilitate selection of the proper club at any given time anywhere on the course.

2. Description of the Background Art

Golf is one of the fastest growing sports today. More and more people, including men, women, boys, girls, the young and not so young, are playing golf. In the game of golf, wind often plays a major factor in the trajectory of a golf ball. Accordingly, golfers typically try to analyze the strength and direction of the wind when selecting a club. However, it's often difficult to judge the direction and strength of the wind because it can change so rapidly. If a device existed that could allow golfers to more objectively determine the direction wind is blowing and its relative strength, it would help the novice and experienced golfers take strokes off their game. The instant invention addresses this unfulfilled need in the prior art by providing such a wind strength and direction indicating device.

### BRIEF SUMMARY OF THE INVENTION

In light of the foregoing, it is an object of the present invention to provide a golf accessory device that helps a golfer determine the direction the wind is blowing.

It is another object of the instant invention to provide a golf accessory device that helps a golfer determine the relative strength of the wind.

It is also an object of the instant invention to provide a golf accessory device for determining wind direction and strength that can display advertising and other indicia.

It is an additional object of the instant invention to provide a golf accessory device for determining wind direction and strength that is convenient to use.

It is a further object of the instant invention to provide a golf accessory device for determining wind direction and strength that cost effective for manufacturing and mass production.

In light of these and other objects, the instant invention comprises a portable, narrow flag or ribbon that is releasably attachable to golf bags, clubs, and, or carts to provide an indication of the direction the wind is blowing and its relative strength. The instant invention allows the golfer to factor in wind conditions when selecting a club. The wind indicator of the instant invention comprises a flexible elongated strip, fastening ends, fasteners for securely joining the fastener ends and indicia for conveying a desired message. The strip comprises a durable fabric or plastic-based material that is strong enough to stand up to the wind forces. The fasteners are located at or proximal the distal ends and preferably comprise hook-and-loop. The fasteners are joined together to secure one end of the wind indicator to a golf cart rod, golf club, or golf bag ring. The indicator may be manufactured in a variety of colors and styles and may include indicia, such as officially licensed product names, popular sports teams, and company logos, stitched or printed on at least one surface of the strip.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 shows perspective views of the preferred embodiment of the wind indicator in accordance with the instant invention. Wind Wizard is a trademark owned by Applicant and Marlins is the trademark of the Florida Marlins and Major League Baseball, which is being used for illustration purposes only.

FIG. 2 is a perspective view of the preferred embodiment of the wind indicator attached to a golf cart in accordance with the instant invention.

### DETAILED DESCRIPTION OF THE INVENTION

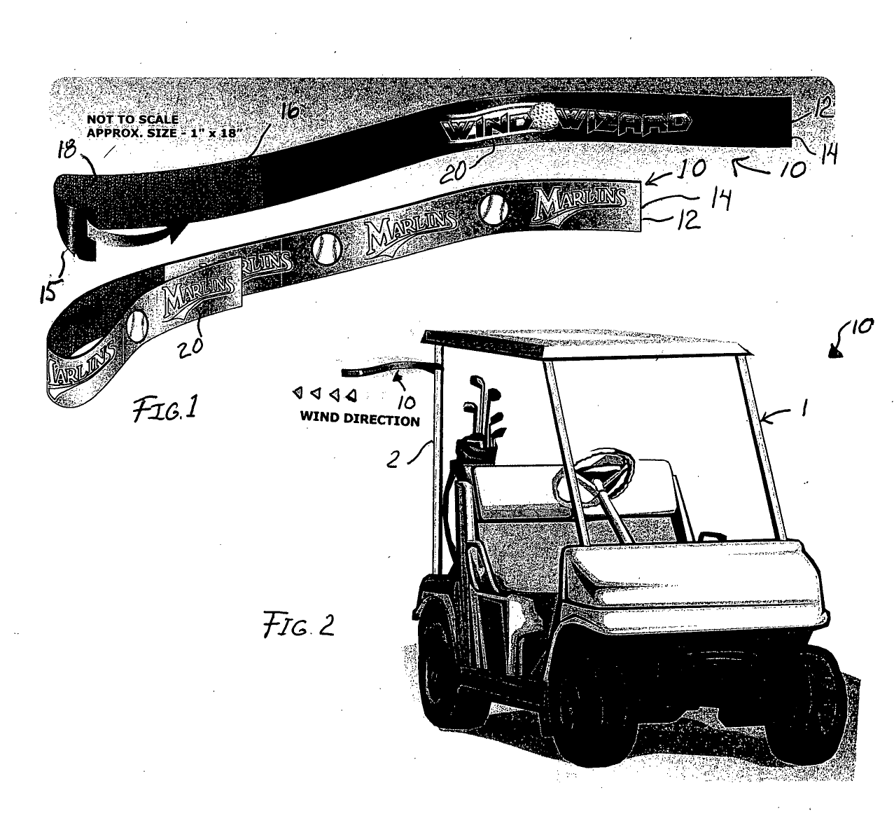

With reference to the drawings, FIGS. 1 and 2 depict the preferred embodiment of the instant invention which is generally referenced as a wind indicator and, or by numeric character 10. The wind indicator 10 is a portable, narrow flag or ribbon that is releasably attachable to a golf cart, club or bag and provides an indication of the direction the wind is blowing and its relative strength. Once a read on the wind is obtained from the indicator 10, the golfer can make an appropriate club selection and ascertain the shot strategy given the wind conditions.

With reference to FIG. 1, the wind indicator 10 comprises an elongated strip 12 having a distal end 14, fastening end 15, hook-and-loop fasteners 16, 18 at the fastening end 15 and indicia 20 for conveying desired messages on at least one surface. The strip 12 comprises a thin, lightweight, durable fabric or plastic-based ribbon material that is strong enough to tolerate wind and rain without tearing but light enough in weight to blow in light wind conditions. The strip 12 preferably measures approximately 1″ in width and 16-18″ in length. The fastener 16, 18 is located at or proximal the distal end 15. The fastener comprises hook-and-loop 16, 18 whereby the hook section or strip 16/18 and the loop section or strip 16/18 are adjacently positioned so that the strips engage when the fastener end 15 is wrapped around a securing device, such as a golf cart rod 2, golf club, or golf bag ring. The fastener strips 16/18 maybe disposed on opposite surfaces of the indicator 10 proximal the distal end 14. The distal end 14 may include a half-diamond cut design so that the flag could flap in the wind appropriately. The indicator 10 may be manufactured in a variety of colors and styles and may include indicia 20, such as officially licensed product names, popular sports teams, and company logos, stitched or printed on at least one surface of the strip 12.

The instant invention 10 is easily used by anyone. To use the wind indicator 10, the strip 12 is wrapped around a rod-like structure, such as a club or on the golf bag or golf cart, such that the hook-and-loop strips 16, 18 align one over the other. Then the hook-and-loop strips 16, 18 are engaged. Once secured, the wind indicator 10 will extend in the direction of the wind and flap with an intensity that is proportional to the strength of the wind. Based on the movement of the indicator 10, the golfer is able to account for the wind when selecting a club and deciding how to play the shot.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

1. A wind direction and relative strength indicator device, said device comprising:
a flexible, lightweight, elongated ribbon, said ribbon having a first end, second end, inside surface and outside surface;
means for fastening said first end around a pole-like structure, said fastening means being disposed on said first surface at least proximal said first end; and
indicia on at least one of said surfaces for conveying a message.

2. A device as recited in claim 1, wherein said second end has at least a partial diamond-like cut.

3. A device as recited in claim 1, wherein said ribbon comprises a thin plastic-based material.

4. A device as recited in claim 1, wherein said ribbon comprises a thin fabric-based material.

5. A device as recited in claim 1, wherein said ribbon is approximately one inch in width and approximately sixteen inches in length.

6. A device as recited in claim 1, wherein said ribbon is approximately ½ an inch to 1.5 inches in width and approximately sixteen to eighteen inches in length.

7. A device as recited in claim 1, wherein said fastening means comprises:
at least one hook-and-loop strip.

8. A device as recited in claim 1, wherein said fastening means comprises:
a first hook-and-loop strip; and
a second hook-and-loop strip operatively corresponding to said first hook-and-loop strip, said first and second hook-and-loop strips being adjacently secured to said inside surface of said ribbon.

9. A device as recited in claim 1, wherein said fastening means comprises:
a first hook-and-loop strip secured to said inside surface; and
a second hook-and-loop strip operatively corresponding to said first hook-and-loop strip, said second hook-and-loop strip being secured to said outside surface.
